(19) United States
(12) Patent Application Publication
(10) Pub. No.: US 2021/0008711 A1
(43) Pub. Date: Jan. 14, 2021

(54) ROBOTIC DEVICE, ROBOTIC DEVICE CONTROLLING SYSTEM, AND ROBOTIC DEVICE CONTROLLING METHOD

(71) Applicant: KYOCERA Document Solutions Inc., Osaka (JP)

(72) Inventor: Kohei MORIGUCHI, Osaka-shi (JP)

(73) Assignee: KYOCERA Document Solutions Inc., Osaka (JP)

(21) Appl. No.: 16/924,664

(22) Filed: Jul. 9, 2020

(30) Foreign Application Priority Data
Jul. 11, 2019 (JP) 2019-129297

(51) Int. Cl. B25J 9/00; B25J 9/16; G05B 19/42

(52) U.S. Cl. CPC B25J 9/0081; G05B 19/42; B25J 9/1697

(57) ABSTRACT

A robotic device performs work defined by a series of unit jobs. The robotic device includes a first notice section and a controller. The controller includes a first calculation section that calculates end time of the work based on time required for the work. The controller controls the first notice section so that the first notice section issues notice of ending the work before the end time. The controller further includes a first determination section that determines, based on the end time, time to issue the notice. The time to issue the notice is time before the end time.

### INCORPORATION BY REFERENCE

The present application claims priority under 35 U.S.C. § 119 to Japanese Patent Application No. 2019-129297, filed on Jul. 11, 2019. The contents of this application are incorporated herein by reference in their entirety.

### BACKGROUND

The present disclosure relates to a robotic device, a robotic device controlling system, and a robotic device controlling method.

An articulated robotic device includes an end effector device and a robotic hand device. The articulated robotic device allows a worker to set movement of the articulated robotic device by directly moving the end effector device. Further, the articulated robotic device can perform work by performing the set movement.

### SUMMARY

A robotic device according to a first aspect of the present disclosure repeats work defined by a series of unit jobs. The robotic device includes a first notice section and a controller. The controller includes a first calculation section that calculates end time of the work based on time required for the work. The controller controls the first notice section so that the first notice section issues notice of ending the work before the end time.

A robotic device controlling system according to a second aspect of the present disclosure includes a robotic device and an external device. The robotic device repeats work defined by a series of unit jobs. The external device communicates with the robotic device through a network. The robotic device includes a first calculation section, a first determination section, a first notice section, a first imaging section, a determining section, a second determination section, and a first communication section. The first calculation section calculates end time of the work. The first determination section determines time to issue notice of ending the work. The first notice section issues the notice of ending the work. The first imaging section captures an image to generate captured image data representing a result of capture. The determining section determines whether or not an image of an administrator of the robotic device is contained in the captured image data. The second determination section determines a notice source of the notice. The first communication section communicates with the external device. The external device is placed in a room that differs from a room where the robotic device is placed. The external device includes a second imaging section, a second notice section, and a second communication section. The second imaging section captures an image to generate captured image data representing a result of capture. The second notice section issues the notice of ending the work. The second communication section communicates with the robotic device. The first calculation section calculates the end time of the work based on time required for the work. The first determination section determines time to issue the notice based on the end time. The time to issue the notice is time before the end time. The first communication section communicates with the second communication section to receive the captured image data generated by the second imaging section. The determining section determines whether or not the image of the administrator is contained in the captured image data generated by the first imaging section based on administrator information representing the administrator of the robotic device. The determining section determines whether or not the image of the administrator is contained in the captured image data generated by the second imaging section based on the administrator information representing the administrator. The second determination section determines which of the first and second notice sections is to issue the notice based on results determined by the determining section.

A robotic device controlling method according to a third aspect of the present disclosure is a control method of a robotic device that repeats work defined by a series of unit jobs. The robotic device controlling method includes calculating end time of the work based on time required for the work, and issuing notice of ending the work before the end time.

### BRIEF DESCRIPTION OF THE DRAWINGS

FIG. 1 illustrates a structure of a robotic device according to a first embodiment of the present disclosure.

FIG. 2 is a structural block diagram of the robotic device according to the first embodiment.

FIG. 3 is a flowchart depicting a process performed by a controller of the robotic device according to the first embodiment.

FIG. 4 is a flowchart depicting a detection process performed by the controller in the first embodiment.

FIG. 5 illustrates a structure of a robotic device controlling system according to a second embodiment of the present disclosure.

FIG. 6 is a structural block diagram of the robotic device controlling system according to the second embodiment.

FIG. 7 is a flowchart depicting a process performed by a controller in the second embodiment.

FIG. 8 is a flowchart depicting a detection process performed by the controller in the second embodiment.

### DETAILED DESCRIPTION

Embodiments of the present disclosure will hereinafter be described with reference to the accompanying drawings. Elements that are the same or equivalent are labelled with the same reference signs in the drawings and description thereof is not repeated.

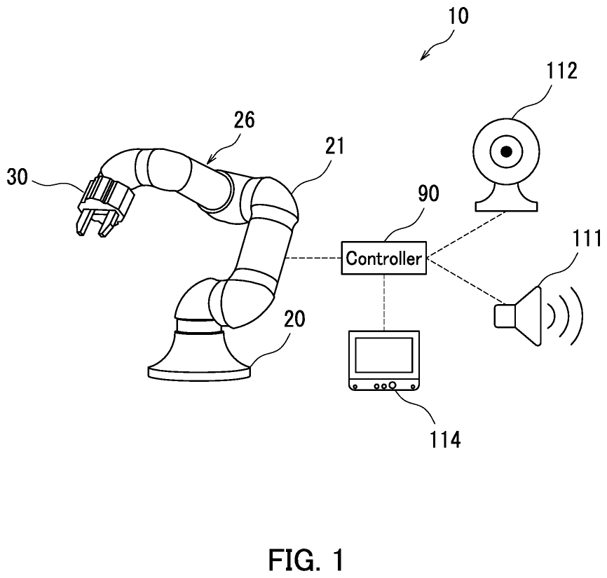

A structure of a robotic device 10 according to an embodiment of the present disclosure will first be described with reference to FIG. 1. FIG. 1 illustrates the structure of the robotic device 10. The robotic device 10 performs work. Specifically, the robotic device 10 repeats the work defined by a series of unit jobs. The work defined by the series of unit jobs includes acts of the robotic device 10. The acts of the robotic device 10 include for example an “act of gripping a material”. The acts of the robotic device 10 also include for example an “act to be performed with respect to the gripped material”. That is, the robotic device 10 sequentially performs the acts and can thereby perform the work defined by the series of unit jobs, which an administrator of the robotic device 10 desires.

The robotic device 10 is placed for example in a predetermined position in a factory. For example, the robotic device 10 is placed on an assembly line in the factory. That is, the robotic device 10 performs the work on the assembly line in the factory. Note that more than one robotic devices 10 may be placed on the assembly line.

As illustrated in FIG. 1, the robotic device 10 includes a robotic hand device 26, an audio output section 111, an imaging section 112, a display section 114, and a controller 90.

The robotic hand device 26 includes a base 20, arm sections, a shoulder section 21, a wrist section, and an end effector device 30. The robotic hand device 26 is for example an articulated robotic device.

The base 20 supports the arm sections, the shoulder section 21, the wrist section, and the end effector device 30.

The arm sections are coupled to each other. Each of the arm sections has a rotation axis. Each of the arm sections pivots on a corresponding rotation axis. For example, one of the arm sections is coupled to the shoulder section 21 and allowed to pivot on a corresponding rotation axis extending in a direction intersecting with a rotation axis of the shoulder section 21.

The shoulder section 21 is coupled to the base 20 and allowed to pivot on the rotation axis thereof.

The wrist section pivots on a rotation axis thereof. The wrist section is coupled to one of the arm sections. The wrist section pivots on the rotation axis thereof extending in a direction intersecting with the rotation axis of the arm section coupled to the wrist section.

The end effector device 30 grips a material. The end effector device 30 is exchangeable and connected to a distal end of the robotic hand device 26. The end effector device 30 is configured as a gripping mechanism that includes a housing, a first finger, and a second finger. The housing is coupled to a distal end of the wrist section and allowed to twist and turn. The first and second fingers protrude from an opening located in the housing.

The audio output section 111 outputs a sound. The audio output section 111 is for example a speaker. Specifically, the audio output section 111 outputs audio based on audio data. The audio data represents audio issuing notice of ending the work. The audio data represents audio such as “Work will be completed in 5 minutes” or “Work ends at hh:mm”. Here, “hh” represents hours (00 to 23), and “mm” represents minutes (00 to 59). The audio output section 111 is placed on a room where the assembly line in the factory is installed. The audio output section 111 corresponds to an example of a “notice section”. The audio output section 111 also corresponds to an example of a “first notice section”.

The imaging section 112 captures an image to generate captured image data representing a result of capture. Specifically, the imaging section 112 captures an image of a subject to generate captured image data representing a result of capture. The subject is a predetermined area that can be captured from a position in which the imaging section 112 is placed. That is, the imaging section 112 captures an image in the predetermined area of a room in which the robotic device 10 is placed. An image of the administrator may be contained in the captured image data that contains the image of the subject. The imaging section 112 is placed in the room in which the assembly line in the factory is installed.

The imaging section 112 is for example an image sensor. Examples of the image sensor include a charge coupled device (CCD) image sensor and a complementary metal oxide semiconductor (CMOS) image sensor. The image sensor generates the captured image data to be transmitted to the controller 90.

The display section 114 displays various images. The display section 114 is for example a liquid-crystal display (LCD). The display section 114 notifies information on the robotic device 10. The information on the robotic device 10 is for example information on an image issuing the notice of ending the work. The image issuing the notice of ending the work is a character image indicating for example “Work will be completed in 5 minutes” or “Work ends at hh:mm”. The display section 114 is placed in the room in which the assembly line in the factory is installed. The display section 114 corresponds to an example of a “notice section”.

The controller 90 includes a processor. The processor is a hardware circuit that includes a central processing unit (CPU), an application specific integrated circuit (ASIC), or the like.

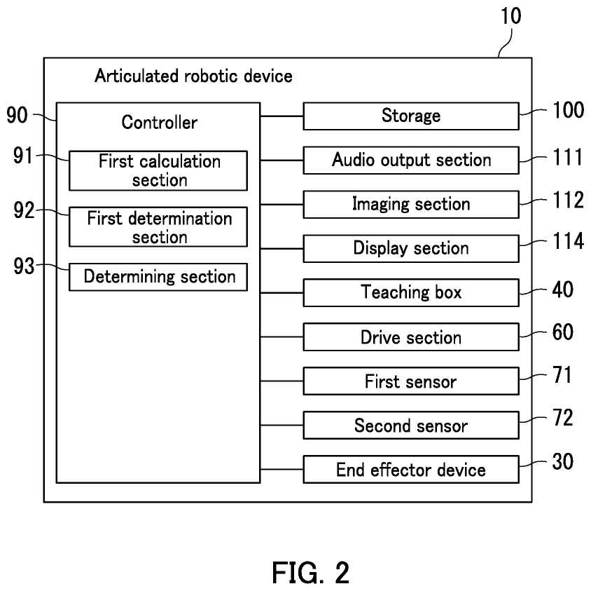

A structure of the robotic device 10 will next be described with reference to FIGS. 1 and 2. FIG. 2 is a structural block diagram of the robotic device 10. As illustrated in FIG. 2, the robotic device 10 further includes a teaching box 40, a drive section 60, a first sensor 71, a second sensor 72, and storage 100.

The teaching box 40 supplies the controller 90 with a signal indicating an instruction from the administrator when performing teaching of the robot device 10. For example, the teaching box 40 supplies the controller 90 with a signal indicating an instruction to start direct teaching and a signal indicating an instruction to end the direct teaching. The direct teaching indicates that the administrator directly moves the robotic hand device 26 to set a position and a posture of the robotic hand device 26.

The drive section 60 includes a motor driver, motors, and encoders. The motors are individually arranged at joints of the robotic hand device 26. The motor driver drives the motors. The motors drive so as to rotate the joints of the robotic hand device 26. The encoders detect respective rotations of the motors arranged at the joints of the robotic hand device 26 to transmit respective signals to the controller 90.

The controller 90 provides a control signal to the motor driver so as to control movement of the robotic hand device 26. Signals output from the encoders are fed back to the controller 90. The signals output from the encoders enable the controller 90 to specify the movement of the robotic hand device 26.

The first sensor 71 outputs a signal indicating magnitude and direction of an external force applied to the end effector device 30 by the administrator. The first sensor 71 is a six-axis force sensor. The first sensor 71 is inserted between the robotic hand device 26 and the end effector device 30. An output signal of the first sensor 71 is supplied to the controller 90. The controller 90 detects the external force applied to the end effector device 30 by the administrator based on the output signal of the first sensor 71.

The second sensor 72 detects a pressing force onto a material by the first finger. The second sensor 72 also detects a pressing force onto the material by the second finger. The second sensor 72 is built in the end effector device 30. An output signal of the second sensor 72 is supplied as a feedback signal to the controller 90.

The storage 100 includes a storage device and stores therein data and control programs. The storage device includes main memory such as semiconductor memory and an auxiliary storage device such as a hard disk drive (HDD). The storage device may include a removal medium. The storage device stores therein the control programs. The processor of the controller 90 executes a control program stored in the storage 100, thereby controlling each of constituent parts of the robotic device 10.

The controller 90 of the robotic device 10 will next be described in detail with reference to FIG. 2. The controller 90 includes a first calculation section 91. The controller 90 executes the control program, thereby functioning as the first calculation section 91.

The first calculation section 91 calculates end time of the work performed by the robotic device 10. Specifically, the first calculation section 91 calculates the end time of the work performed by the robotic device 10 based on time required for the work.

The controller 90 in the present embodiment then controls the notice section so that the notice section issues the notice of ending the work. Specifically, the controller 90 controls the audio output section 111 or the display section 114 so that the audio output section 111 or the display section 114 issues the notice of ending the work before the end time. Thus, the notice being given to the administrator before the work ends enables the administrator to immediately instruct the robotic device 10 to perform next work after the robotic device 10 ends the work. It is therefore possible to reduce time between work and work, during which the robotic device 10 performs no work. As a result, a decrease in work efficiency of the work performed by the robotic device 10 can be suppressed.

For example, the robotic device 10 allows the administrator to enter therein an instruction to perform predetermined work multiple times. The predetermined work is defined by a series of unit jobs. The first calculation section 91 acquires information on the work from the storage 100 based on the instruction. The information on the work includes information indicating the series of unit jobs and information indicating time required for the acts.

The information indicating the series of unit jobs includes for example information indicating four acts of the robotic devices 10. For example, the information indicating the four acts of the robotic devices 10 includes first act information, second act information, third act information, and fourth act information. The first act information includes for example instructing the robotic device 10 to grip a material. The second act information includes for example instructing the robotic device 10 to carry the gripped material to a predetermined position. The third act information includes for example instructing the robotic device 10 to place the carried material in the predetermined position. The fourth act information includes for example instructing the robotic device 10 to return to an original position.

Time required for acts performed by the robotic device 10 according to the first to fourth act information is measured for each act in advance. The first calculation section 91 then calculates time required for the series of unit jobs based on time required for each act acquired from the storage 100. This enables the first calculation section 91 to calculate time required for series of unit jobs per time. Time required for the act on the first act information is for example “ten seconds”. Time required for the act on the second act information is for example “twenty seconds”. Time required for the act on the third act information is for example “ten seconds”. Time required for the act on the fourth act information is for example “twenty seconds”. That is, the time required for the series of unit jobs is “sixty seconds”.

The first calculation section 91 calculates the time required for the work based on the time required for the series of unit jobs and the number of repetitions of the series of unit jobs. For example, the administrator enters an instruction to perform the work 60 times into the robotic device 10. For example, the first calculation section 91 calculates work time, during which the series of unit jobs taking “60 seconds” is repeated “60 times”. That is, the first calculation section 91 figures out 60 minutes as the time required for the work instructed from the administrator.

The first calculation section 91 then calculates, as the end time of the work, time when 60 minutes have passed since start time of the work. In addition, the controller 90 controls the notice section so that the notice section issues the notice of ending the work before the end time. This enables the administrator to instruct the robotic device 10 to perform next work immediately after previous work ends. As a result, work efficiency is improved.

When issuing notice of ending the work, the controller 90 controls the audio output section 111 or the display section 114 so that the audio output section 111 or the display section 114 issues the notice.

For example, the controller 90 controls the audio output section 111 so that the audio output section 111 issues the notice of ending the work before the end time. Specifically, the controller 90 controls the audio output section 111 so that the audio output section 111 gives the administrator the notice of ending the work before the end time. The audio output section 111 outputs the notice based on an instruction from the controller 90. It is therefore possible to give the administrator the notice by audio. As a result, even if the administrator is in a position away from the robotic device 10, the administrator can be given the notice of ending the work.

In addition, the controller 90 controls the display section 114 so that the display section 114 issues the notice of ending the work before the end time. Specifically, the controller 90 controls the display section 114 so that the display section 114 gives the administrator the notice of ending the work before the end time. It is therefore possible to give the administrator the notice by the character image. As a result, when the administrator is in a position where the display section 114 of the robotic device 10 can be visually recognized, the administrator can be given the notice of ending the work even in a factory where a work sound is large.

The structure of the controller 90 will next be described with reference to FIG. 2. The controller 90 further includes a first determination section 92 and a determining section 93. The controller 90 executes the control program, thereby functioning as the first determination section 92 and the determining section 93.

Based on the end time, the first determination section 92 determines time to issue the notice. Specifically, based on the end time calculated by the first calculation section 91, the first determination section 92 determines the time to issue the notice of ending the work. The time to issue the notice is time before the end time.

The controller 90 in the present embodiment then controls the notice section so that the notice section issues the notice of ending the work at the time determined by the first determination section 92. Since the time at which the administrator is given the notice is determined, the administrator returning to the room in which the robotic device 10 is placed earlier than the determined time can be presented. It is therefore possible to prevent the administrator wasting time in the room where the robotic device 10 is placed. As a result, the convenience for the administrator is improved.

For example, the first determination section 92 sets time five minutes before the end time calculated by the first calculation section 91 to the time to issue the notice of ending the work. That is, if the end time of the work calculated by the first calculation section 91 is “14:00”, the first determination section 92 sets the time to issue the notice of ending the work to “13:55”. The controller 90 performs notifying control of the notice of ending the work at time “13:55” set by the first determination section 92.

This enables the administrator to know that the work being performed by the robotic device 10 will end after 5 minutes. It is therefore possible to prevent the administrator wasting time in the room where the robotic device 10 is placed and to improve the convenience for the administrator.

The determining section 93 determines whether or not an image of the administrator is contained in the captured image data based on administrator information representing the administrator of the robotic device 10. Determination can therefore be made as to whether or not the administrator giving instructions to the robotic device 10 is near the robotic device 10. This enables preventing workers other than the administrator from being erroneously given the notice.

The administrator information representing the administrator of the robotic device 10 is stored in the storage 100. The administrator information represents for example a face of a specific person. That is, the determining section 93 determines whether or not the captured image data contains an image that matches an image represented by the information representing the face of the specific person. This enables the determining section 93 to determine the authenticity of the administrator of the robotic device 10.

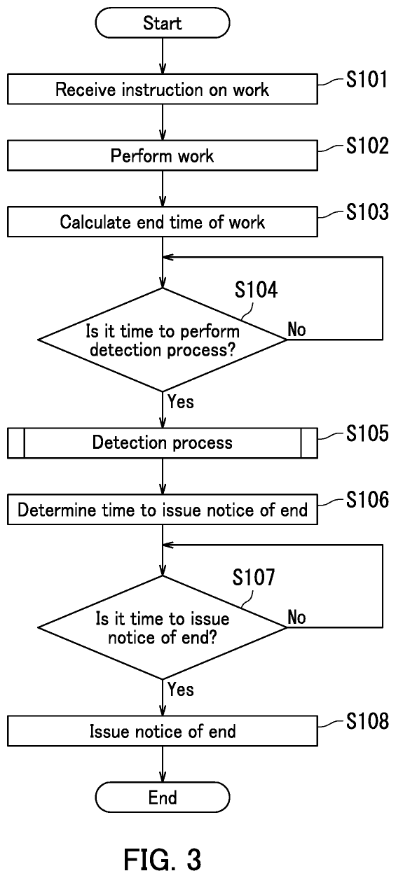

A process performed by the controller 90 will next be described with reference o FIG. 3. FIG. 3 is a flowchart depicting the process performed by the controller 90 of the robotic device 10. The process performed by the controller 90 includes Steps S101 to S108.

In Step S101, the controller 90 receives an instruction on work. The process then proceeds to Step S102.

In Step S102, the controller 90 controls the robotic hand device 26 and causes the robotic hand device 26 to perform the work defined by a series of unit jobs. The process then proceeds to Step S103.

In Step S103, the first calculation section 91 calculates end time of the work based on time required for the work. The process then proceeds to Step S104.

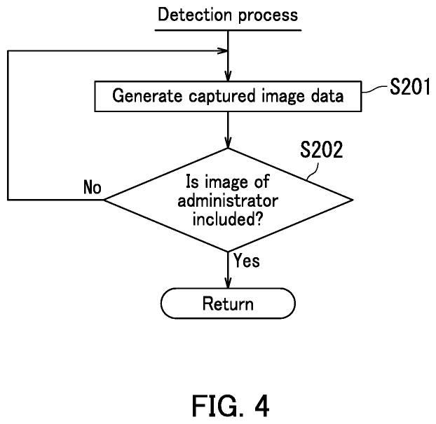

In Step S104, the controller 90 determines whether or not it is time to perform a detection process. The detection process will be described later with reference to FIG. 4. If it is not time to perform the detection process (Step S104, No), the process repeats Step S104. If it is time to perform the detection process (Step S104, Yes), the process proceeds to Step S105.

If Yes in Step S104, the process proceeds to Step S105 to cause the controller 90 to perform the detection process. The process then proceeds to Step S106.

In Step S106, based on the end time of the work, the first determination section 92 determines time to issue notice of ending the work. The process then proceeds to Step S107.

In Step S107, the controller 90 determines whether or not it is time to issue the notice of ending the work. If it is not time to issue the notice (Step S107, No), the process repeats Step S107. If it is time to issue the notice (Step S107, Yes), the process proceeds to Step S108.

If Yes in Step S107, the process proceeds to Step S108 to cause the controller 90 to control the audio output section 111 or the display section 114 so that the audio output section 111 or the display section 114 issues the notice of ending the work. The process then ends.

The detection process will next be described with reference to FIG. 4. FIG. 4 is a flowchart depicting the detection process performed by the controller 90. The detection process performed by the controller 90 includes Steps S201 and S202. The detection process performed by the controller 90 corresponds to Step S105 depicted in FIG. 3.

In Step S201, the controller 90 controls the imaging section 112 so that the imaging section 112 captures an image to generate captured image data representing a result of capture. The process then proceeds to Step S202.

In Step S202, the determining section 93 determines whether or not an image of the administrator is contained in the captured image data based on the administrator information representing the administrator of the robotic device 10. If the image of the administrator is contained in the captured image data (Step S202, Yes), the process returns to Step S106 depicted in FIG. 3. If the image of the administrator is not contained in the captured image data (Step S202, No) the process returns to Step S201.

### Second Embodiment

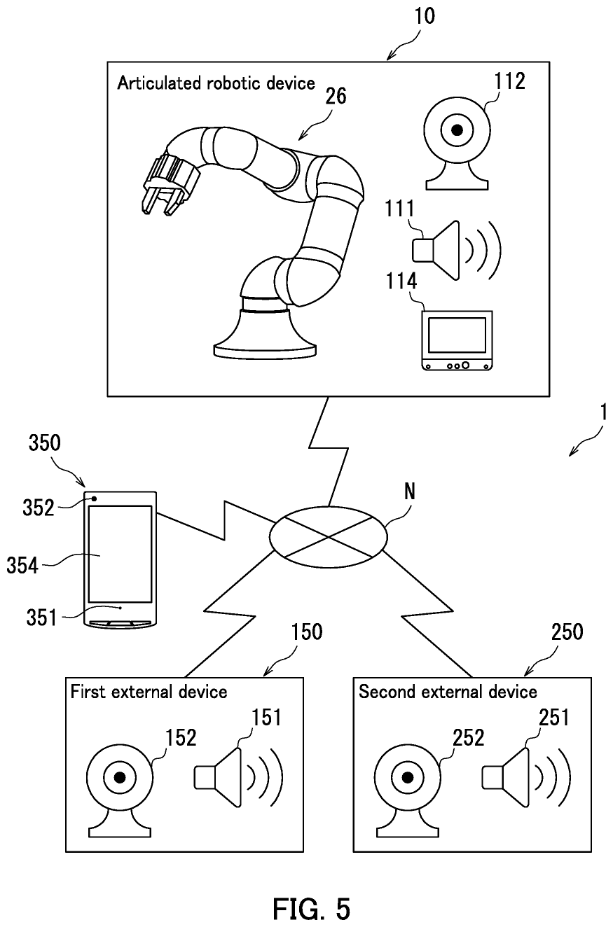

A structure of a robotic device controlling system 1 according to a second embodiment of the present disclosure will next be described with reference to FIG. 5. FIG. 5 illustrates the structure of the robotic device controlling system 1. As illustrated in FIG. 1, the robotic device controlling system 1 includes a robotic device 10 and external devices. One of the external devices is a first external device 150. Another one of the external devices is a second external device 250. Yet another one of the external devices is a third external device 350.

The robotic device 10, the first external device 150, the second external device 250, and the third external device 350 are connected to each other and allowed to communicate with each other through the network N. Examples of the network N include the Internet, a local area network (LAN), and a wide area network (WAN). Various communication devices are connected to the network N. Examples of the communication devices include a router, a bridge, an access point, a hub, and a repeater.

The robotic device 10 is allowed to communicate with the first external device 150 through the network N. The robotic device 10 is also allowed to communicated with the second external device 250 through the network N. In addition, the robotic device 10 is allowed to communicate with the third external device 350 through the network N.

As illustrated in FIG. 5, the robotic device 10 includes a robotic hand device 26, an audio output section 111, an imaging section 112, and a display section 114. The robotic hand device 26, the audio output section 111, the imaging section 112, and the display section 114 have been described in the first embodiment and a description thereof will be omitted.

The first external device 150 communicates with the robotic device 10 through the network N. The first external device 150 executes instructions from the robotic device 10. The first external device 150 is placed in a predetermined room in a factory. The predetermined room in the factory where the first external device 150 is placed differs from for example a room where the robotic device 10 is placed. The room where the first external device 150 is placed is for example a “conference room”.

The first external device 150 includes a first external audio output section 151 and a first external imaging section 152. The first external audio output section 151 and the first external imaging section 152 are placed in the same room. That is, the first external audio output section 151 and the first external imaging section 152 are placed in the “conference room”. Note that the first external audio output section 151 and the first external imaging section 152 may be spaced apart in the “conference room”.

The first external audio output section 151 outputs a sound. The first external audio output section 151 is for example a speaker. Specifically, the first external audio output section 151 outputs audio based on audio data. The audio data is transmitted from the robotic device 10. The first external audio output section 151 corresponds to an example of a “second notice section”.

The first external imaging section 152 captures an image to generate captured image data representing a result of capture. Specifically, the first external imaging section 152 captures an image of a subject to generate captured image data representing a result of capture. The subject is a predetermined area that can be captured from a position in which the first external imaging section 152 is placed. For example, the first external imaging section 152 photographs a predetermined area of the “conference room” where the first external device 150 is placed. An image of the administrator may be contained in the captured image data generated by the first external imaging section 152. The first external imaging section 152 is for example an image sensor. Examples of the image sensor include a CCD image sensor and a CMOS image sensor. The image sensor generates the captured image data to be transmitted to the robotic device 10.

The second external device 250 communicates with the robotic device 10 through the network N. The second external device 250 executes instructions from the robotic device 10. The second external device 250 is placed in a predetermined room in the factory. The predetermined room in the factory where the second external device 250 is placed differs from for example the room where the robotic device 10 is placed and the room where the first external device 150 is placed. The predetermined room where the second external device 250 is placed is for example a “trial manufacturing room”.

The second external device 250 includes a second external audio output section 251 and a second external imaging section 252. The second external audio output section 251 and the second external imaging section 252 are placed in the same room. That is, the second external audio output section 251 and the second external imaging section 252 are placed in the “trial manufacturing room”. Note that the second external audio output section 251 and the second external imaging section 252 may be spaced apart in the “trial manufacturing room”.

The second external audio output section 251 outputs a sound. The second external audio output section 251 is for example a speaker. Specifically, the second external audio output section 251 outputs audio based on audio data. The audio data is transmitted from the robotic device 10. The second external audio output section 251 corresponds to an example of the “second notice section”.

The second external imaging section 252 captures an image to generate captured image data representing a result of capture. Specifically, the second external imaging section 252 captures an image of a subject to generate captured image data representing a result of capture. The subject is a predetermined area that can be captured from a position in which the second external imaging section 252 is placed. For example, the second external imaging section 252 photographs a predetermined area of the “trial manufacturing room” where the second external device 250 is placed. An image of the administrator may be contained in the captured image data generated by the second external imaging section 252. The second external imaging section 252 is for example an image sensor. Examples of the image sensor include a CCD image sensor and a CMOS image sensor. The image sensor generates the captured image data to be transmitted to the robotic device 10.

The third external device 350 is a portable terminal device. The third external device 350 is for example a terminal device of the administrator who operates the robotic device 10. The third external device 350 communicates with the robotic device 10 through the network N. The third external device 350 executes instructions from the robotic device 10.

The third external device 350 includes a third external audio output section 351, a third external imaging section 352, and a third external display section 354. The third external audio output section 351 outputs a sound. Specifically, the third external audio output section 351 outputs audio based on audio data. The audio data is transmitted from the robotic device 10. The third external audio output section 351 is for example a speaker. The third external audio output section 351 is an example of the “second notice section”.

The third external imaging section 352 captures an image of a subject. The subject is a predetermined area that can be captured by the third external imaging section 352 from a position in which the third external device 350 is placed. For example, the third external imaging section 352 photographs a predetermined area of an “office room” where the third external device 350 is placed.

The third external imaging section 352 captures an image to generate captured image data representing a result of capture. Specifically, the third external imaging section 352 captures an image of a subject to generate captured image data representing a result of capture. The subject is a predetermined area that can be captured from a position in which the third external imaging section 352 is placed. For example, the third external imaging section 352 photographs a predetermined area of the “office room” where the third external device 350 is placed. An image of the administrator may be contained in the captured image data generated by the third external imaging section 352. The third external imaging section 352 is for example an image sensor. Examples of the image sensor include a CCD image sensor and a CMOS image sensor. The image sensor generates the captured image data to be transmitted to the robotic device 10.

A third external display section 354 displays various images. The third external display section 354 is for example a liquid crystal display (LCD). The third external display section 354 notifies information on the robotic device 10. The information on the robotic device 10 is for example information on an image issuing notice of ending work. The third external display section 354 is an example of the “second notice section”.

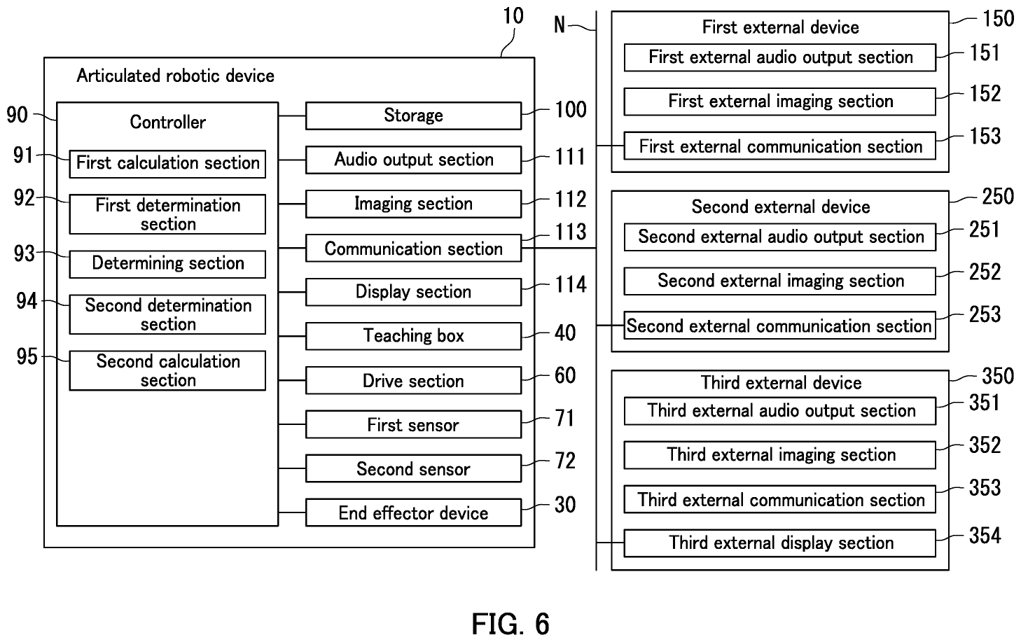

Next, a structure of the robotic device controlling system 1 according to the second embodiment will further be described in detail with reference to FIG. 6. FIG. 6 is a structural block diagram of the robotic device controlling system 1 according to the second embodiment.

As illustrated in FIG. 6, the robotic device 10 further includes a communication section 113. The communication section 113 communicates with the first external device 150, the second external device 250, and the third external device 350 through the network N. Specifically, the communication section 113 receives a signal from each of the first external device 150, the second external device 250, and the third external device 350 through the network N. The signal is for example a signal containing captured image data.

The communication section 113 transmits a control signal to the first external device 150, the second external device 250, and the third external device 350 through the network N. The communication section 113 transmits for example individual control signals to the first external device 150, the second external device 250, and the third external device 350. Here, each of the control signals is a signal instructing a corresponding one of the first external device 150, the second external device 250, and the third external device 350 to capture an image of a subject to generate captured image data. The communication section 113 transmits for example a control signal that gives the notice of ending the work to one of the first external device 150, the second external device 250, and the third external device 350. The communication section 113 corresponds to an example of the “first notice section”.

The first external device 150 further includes a first external communication section 153. The first external communication section 153 communicates with the robotic device 10 through the network N. Specifically, the first external communication section 153 transmits the captured image data generated by the first external imaging section 152 to the communication section 113. The first external communication section 153 also receives a control signal from the communication section 113. The control signal is for example a signal instructing the first external imaging section 152 to capture an image of a subject to generate captured image data. The control signal also contains for example a control instruction to cause the first external audio output section 151 to output audio issuing the notice of ending the work.

The second external device 250 further includes a second external communication section 253. The second external communication section 253 communicates with the robotic device 10 through the network N. Specifically, the second external communication section 253 transmits the captured image data generated by the second external imaging section 252 to the communication section 113. The second external communication section 253 also receives a control signal from the communication section 113. The control signal is for example a signal instructing the second external imaging section 252 to capture an image of a subject to generate captured image data. The control signal contains for example a control instruction to cause the second external audio output section 251 to output audio issuing the notice of ending the work.

The third external device 350 further includes a third external communication section 353. The third external communication section 353 communicates with the robotic device 10 through the network N. Specifically, the third external communication section 353 transmits the captured image data generated by the third external imaging section 352 to the communication section 113. The third external communication section 353 also receives a control signal from the communication section 113. The control signal contains for example a control instruction to cause the third external imaging section 352 to capture an image of a subject to generate captured image data. The control signal contains for example a control instruction to cause the third external audio output section 351 to output audio issuing the notice of ending the work. The control signal contains for example a control instruction to cause the third external display section 354 to display an image issuing the notice of ending the work.

The structure of the controller 90 of the robotic device 10 will next be described in detail with reference to FIG. 6. The description of elements equivalent to those in the first embodiment will be omitted.

A determining section 93 in the second embodiment determines whether or not an image of the administrator is contained in the captured image data generated by the imaging section 112. In addition, the determining section 93 determines whether or not an image of the administrator is contained in the captured image data generated by the first external imaging section 152. Moreover, the determining section 93 determines whether or not an image of the administrator is contained in the captured image data generated by the second external imaging section 252. Furthermore, the determining section 93 determines whether or not an image of the administrator is contained in the captured image data generated by the third external imaging section 352.

For example, the determining section 93 determines whether or not the image of the administrator is contained in the captured image data generated by the imaging section 112 based on administrator information representing the administrator of the robotic device 10. When the image of the administrator is contained in the captured image data, the determining section 93 transmits, to a controller 90, a first signal indicating that the administrator is in the room where the robotic device 10 is placed. The controller 90 that has received the first signal controls the audio output section 111 or the display section 114 so that the audio output section 111 or the display section 114 gives the administrator the notice of ending the work.

In contrast, when the image of the administrator is not contained in the captured image data, the determining section 93 transmits, to the controller 90, a second signal indicating that the administrator is not in the room where the robotic device 10 is placed. The controller 90 that has received the second signal controls the communication section 113 so that the communication section 113 receives the captured image data generated by the first external imaging section 152.

The determining section 93 then determines whether or not an image of the administrator is contained in the captured image data generated by the first external imaging section 152 based on the administrator information representing the administrator of the robotic device 10. When the image of the administrator is contained in the captured image data, the determining section 93 transmits, to the controller 90, a third signal indicating that the administrator is in the room where the first external device 150 is placed. The controller 90 that has received the third signal controls the communication section 113 so that the communication section 113 transmits a control signal to the first external communication section 153. The control signal contains an instruction to give the administrator the notice of ending the work.

In contrast, when the image of the administrator is not contained in the captured image data, the determining section 93 transmits, to the controller 90, a fourth signal indicating that the administrator is not in the room where the first external device 150 is placed. The controller 90 that has received the fourth signal controls the communication section 113 so that the communication section 113 receives the captured image data generated by the second external imaging section 252.

The determining section 93 then determines whether or not the image of the administrator is contained in the captured image data generated by the second external imaging section 252 based on the administrator information representing the administrator of the robotic device 10. When the image of the administrator is contained in the captured image data, the determining section 93 transmits, to the controller 90, a fifth signal indicating that the administrator is in the room where the second external device 250 is placed. The controller 90 that has received the fifth signal controls the communication section 113 so that the communication section 113 transmits a control signal to the second external communication section 253. The control signal contains an instruction to give the administrator the notice of ending the work.

In contrast, when the image of the administrator is not contained in the captured image data, the determining section 93 transmits, to the controller 90, a sixth signal indicating that the administrator is not in the room where the second external device 250 is placed. The controller 90 that has received the sixth signal controls the communication section 113 so that the communication section 113 receives the captured image data generated by the third external imaging section 352.

The determining section 93 then determines whether or not the image of the administrator is contained in the captured image data generated by the third external imaging section 352 based on the administrator information representing the administrator of the robotic device 10. When the image of the administrator is contained in the captured image data, the determining section 93 transmits, to the controller 90, a seventh signal indicating that the administrator is in the room where the third external device 350 is placed. The controller 90 that has received the seventh signal controls the communication section 113 so that the communication section 113 transmits a control signal to the third external communication section 353. The control signal contains an instruction to give the administrator the notice of ending the work.

In contrast, when the image of the administrator is not contained in the captured image data, the determining section 93 transmits, to the communication section 113, an eighth signal indicating that the administrator is not in the room where the third external device 350 is placed. The communication section 113 that has received the eighth signal communicates with a different external device other than the first, second, and third external devices 150, 250, and 350. The controller 90 then controls the communication section 113 so that the communication section 113 receives the captured image data generated by an external imaging device of the different external device. The communication section 113 receives captured image data from each of the external devices. The determining section 93 then determines whether or not an image of the administrator is contained in the captured image data received from each external device. That is, the controller 90 repeats determination based on the captured image data until the administrator is found.

The structure of the controller 90 of the robotic device 10 will next be described in detail with reference to FIG. 6. The controller 90 further includes a second determination section 94 and a second calculation section 95. The controller 90 executes the control program, thereby functioning as the second determination section 94 and the second calculation section 95.

The second determination section 94 determines a notice source of the notice. Specifically, the second determination section 94 determines which of the first and second notice sections is to issue the notice based on a result determined by the determining section 93. It is therefore possible to cause a notice section to issue the notice of ending the work. Here, the administrator is in the room where the notice section is placed. This enables the administrator to be given the notice of ending the work from a location nearer the administrator.

For example, when receiving the first signal, the second determination section 94 determines that the audio output section 111 or the display section 114 is to issue the notice of ending the work. For example, when receiving the third signal, the second determination section 94 determines that the first external audio output section 151 is to issue the notice of ending the work. For example, when receiving the fifth signal, the second determination section 94 determines that the second external audio output section 251 is to issue the notice of ending the work. For example, when receiving the seventh signal, the second determination section 94 determines that the third external audio output section 351 or the third external display section 354 is to issue the notice of ending the work. It is therefore possible to cause a notice section to issue the notice of ending the work. Here, the administrator is in the room where the notice section is placed.

The second calculation section 95 calculates a distance between the administrator and the robotic device 10. Specifically, the second calculation section 95 calculates the distance between the administrator and the robotic device 10 based on a result determined by the determining section 93.

For example, when having received the first signal, the second calculation section 95 calculates the distance between the administrator and the robotic device 10. For example, the second calculation section 95 calculates the distance between the administrator and the robotic device 10 based on the first signal and map information that indicates a factory map and that is stored in storage 100. The distance calculated by the second calculation section 95 is for example a first distance. For example, the first distance indicates that the distance between the administrator and the robotic device 10 is within 10 m.

For example, when having received the third signal, the second calculation section 95 calculates the distance between the administrator and the robotic device 10. For example, the second calculation section 95 calculates the distance between the administrator and the robotic device 10 based on the map information stored in the storage 100 and the third signal. Specifically, the second calculation section 95 calculates a distance between the “conference room” and a “room where an assembly line in the factory is installed” based on the map information stored in the storage 100 and the third signal. The distance calculated by the second calculation section 95 is for example a second distance. For example, the second distance indicates that the distance between the administrator and the robotic device 10 is within 20 m.

When having received the fifth signal, the second calculation section 95 calculates the distance between the administrator and the robotic device 10. For example, the second calculation section 95 calculates the distance between the administrator and the robotic device 10 based on the map information stored in the storage 100 and the fifth signal. Specifically, the second calculation section 95 calculates a distance between a “trial manufacturing room” and the “room where the assembly line in the factory is installed” based on the map information stored in the storage 100 and the fifth signal. The distance calculated by the second calculation section 95 is for example a third distance. For example, the third distance indicates that the distance between the administrator and the robotic device 10 is within 30 m.

For example, when having received the seventh signal, the controller 90 acquires position information from the third external device 350. The position information is acquired from for example a global positioning system (GPS) possessed by the third external device 350. For example, the second calculation section 95 calculates the distance between the administrator and the robotic device 10 based on the map information stored in the storage 100 and the position information. Specifically, the second calculation section 95 calculates a distance between an “office room” and the “room where the assembly line in the factory is installed” based on the map information stored in the storage 100 and the position information. The distance calculated by the second calculation section 95 is for example a fourth distance. The fourth distance is changed according to for example the position of the third external device 350. Based on end time of the work and the distance, a first determination section 92 in the present embodiment then determines time to issue the notice. Specifically, based on the end time of the work calculated by a first calculation section 91 and the distance calculated by the second calculation section 95, the first determination section 92 determines the time to issue the notice. More specifically, the first determination section 92 acquires information on the time to issue the notice, from a table stored in the storage 100 based on the distance calculated by the second calculation section 95. In the table, time required for the administrator reaching the room is associated with each distance between the administrator and the robotic device 10. The time required for the administrator reaching the room is time required for the administrator reaching the room where the robotic device 10 is placed from the room in which the administrator is. Therefore, as the distance between the administrator and the robotic device 10 is longer, the time to issue the notice of ending the work becomes earlier. In contrast, as the distance between the administrator and the robotic device 10 is shorter, the time to issue the notice of ending the work becomes later. Thus, the notice can be issued according to a position of a user.

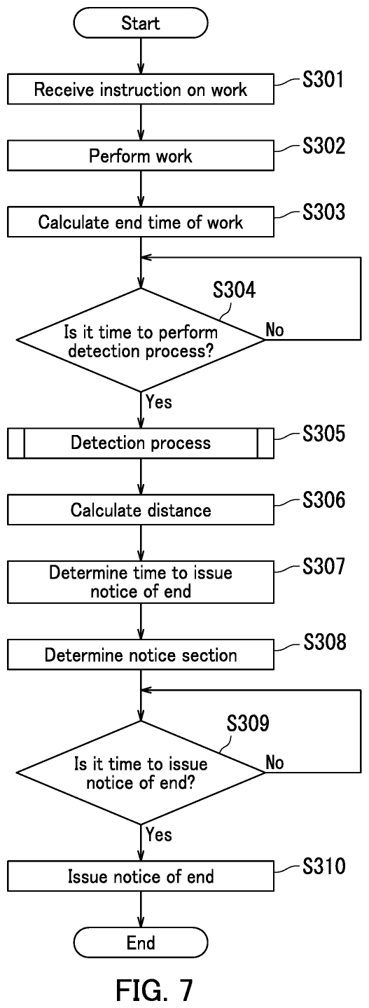

A process performed by the controller 90 will next be described with reference to FIG. 7. FIG. 7 is a flowchart depicting a process performed by the controller 90 of the robotic device 10. The process performed by the controller 90 includes Steps S301 to S310. Note that Steps S301 to S304 depicted in FIG. 7 correspond to Steps S101 to S104 depicted in FIG. 3, respectively. Steps S309 and S310 depicted in FIG. 7 correspond to Steps S107 and S208 depicted in FIG. 3, respectively. Steps S305 to Step 308 depicted in FIG. 7 will therefore be described.

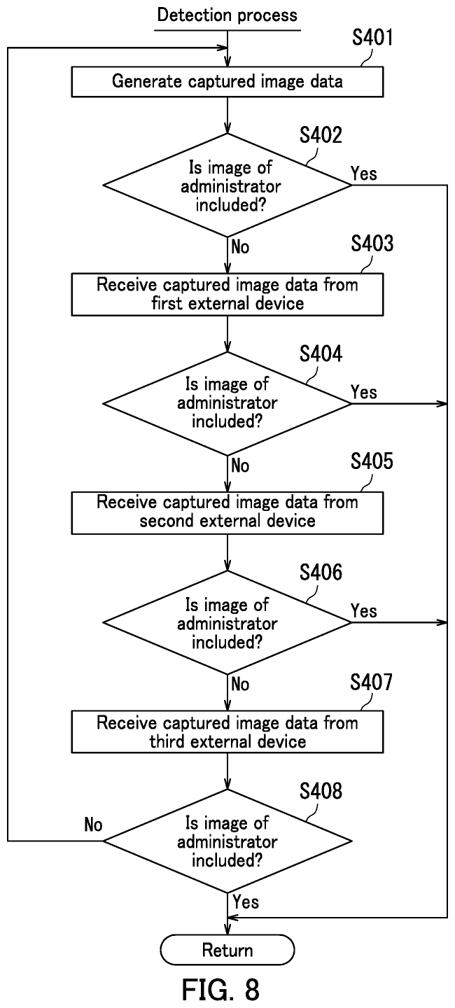

If Yes in Step S304, the process proceeds to Step S305 to cause controller 90 to perform a detection process. The detection process will be described later with reference to FIG. 8. The process then proceeds to Step S306.

In Step S306, the second calculation section 95 calculates a distance between the administrator and the robotic device 10. The process then proceeds to Step S307. In Step S307, based on the end time of the work calculated by the first calculation section 91 and the distance calculated by the second calculation section 95, the first determination section 92 determines the time to issue the notice of ending the work. The process then proceeds to Step S308.

In Step S308, the second determination section 94 determines which of the first and second notice sections is to issue the notice based on a result determined by the determining section 93. The process then proceeds to Step S309.

The detection process will next be described with reference to FIG. 8. FIG. 8 is a flowchart depicting the detection process performed by the controller 90. The detection process performed by the controller 90 includes Steps S401 to S408. The detection process performed by the controller 90 corresponds to Step S305 depicted in FIG. 7.

In Step S401, the controller 90 controls the imaging section 112 so that the imaging section 112 captures an image of a subject to generate captured image data representing a result of capture. The process then proceeds to Step S402.

In Step S402, the determining section 93 determines whether or not an image of the administrator is contained in the captured image data generated by the imaging section 112 based on the administrator information representing the administrator of the robotic device 10. If the image of the administrator is contained in the captured image data (Step S402, Yes), the process returns to Step S306 depicted in FIG. 7. If the image of the administrator is not contained in the captured image data (Step S402, No), the process proceeds to Step S403.

If No in Step S402, the process proceeds to Step S403 to cause the controller 90 to control the communication section 113 so that the communication section 113 receives the captured image data generated by the first external imaging section 152. The process then proceeds to Step S404.

In Step S404, the determining section 93 determines whether or not an image of the administrator is contained in the captured image data generated by the first external imaging section 152 based on the administrator information representing the administrator of the robotic device 10. If the image of the administrator is contained in the captured image data (Step S404, Yes), the process returns to Step S306 depicted in FIG. 7. If the image of the administrator is not contained in the captured image data (Step S404, No), the process proceeds to Step S405.

If No in Step S404, the process proceeds to Step S405 to cause controller 90 to control the communication section 113 so that the communication section 113 receives the captured image data generated by the second external imaging section 252. The process then proceeds to Step S406.

In Step S406, the determining section 93 determines whether or not an image of the administrator is contained in the captured image generated by the second external imaging section 252 based on the administrator information representing the administrator of the robotic device 10. If the image of the administrator is contained in the captured image data (Step S406, Yes), the process returns to Step S306 depicted in FIG. 7. If the image of the administrator is not contained in the captured image data (Step S406, No), the process proceeds to Step S407.

If No in Step S406, the process proceeds to Step S407 to cause the controller 90 to control the communication section 113 so that the communication section 113 receives the captured image data generated by the third external imaging section 352 and the position information of the third external device 350. The process then proceeds to Step S408.

In Step S408, the determining section 93 determines whether or not an image of the administrator is contained in the captured image data generated by the third external imaging section 352 based on the administrator information representing the administrator of the robotic device 10. If the image of the administrator is not contained in the captured image data (Step S408, No), the process returns to Step S401. If the image of the administrator is contained in the captured image data (Step S408, Yes), the process returns to Step S306 depicted in FIG. 7.

As above, the embodiments of the present disclosure have been described with reference to the drawings. However, the present disclosure is not limited to the above-described embodiments and can be practiced in various ways within the scope without departing from the essence of the present disclosure. Constituent elements disclosed in the above embodiments can be combined as appropriate in various different forms. For example, some constituent elements may be omitted from all of the constituent elements described in the embodiments. Further, constituent elements described in different embodiments may be combined as appropriate. The drawings mainly illustrate schematic constituent elements in order to facilitate understanding, and thickness, length, numbers, intervals or the like of each constituent element illustrated in the drawings may differ from actual ones thereof in order to facilitate preparation of the drawings. Further, the speed, material, shape, dimensions, and the like of each constituent element described in the above embodiments are merely examples that do not impose any particular limitations and may be altered in various ways as long as such alterations do not substantially deviate from the configuration of the present disclosure.

(1) In the second embodiment, in order to give the administrator the notice, the robotic device 10 first determines whether or not the administrator is in the room where the robotic device 10 is placed. The robotic device 10 then sequentially determines whether the administrator is in the room where the first external device 150 is placed, in the room where the second external device 250 is placed, or in the room where the third external device 350 is placed. The present disclosure is not limited to this. For example, the robotic device 10 may sequentially determine whether the administrator is in the room where the third external device 350 is placed, in the room where the second external device 250 is placed, or in the room where the first external device 150.

(2) In the second embodiment, in order to give the administrator the notice, the robotic device 10 first determines whether or not the administrator is in the room where the robotic device 10 is placed. The robotic device 10 then sequentially determines whether the administrator is in the room where the first external device 150 is placed, in the room where the second external device 250 is placed, or in the room where the third external device 350 is placed. The present disclosure is not limited to this. For example, the communication section 113 receives the captured image data by the first external imaging section 152, the captured image data by the second external imaging section 252, and the captured image data by the third external imaging section 352.

The determining section 93 then determines whether or not an image of the administrator is contained in the captured image data by the imaging section 112. Further, the determining section 93 determines whether or not an image of the administrator is contained in the captured image data by the first external imaging section 152. Further, the determining section 93 determines whether or not an image of the administrator is contained in the captured image data by the second external imaging section 252. Further, the determining section 93 determines whether or not an image of the administrator is contained in the captured image data by the third external imaging section 352. The second determination section 94 may then determine a notice source of the notice based on results determined by the determining section 93.

What is claimed is:

1. A robotic device that repeats work defined by a series of unit jobs, the robotic device comprising
a first notice section, and
a controller, wherein
the controller includes a first calculation section configured to calculate end time of the work based on time required for the work, and
the controller controls the first notice section so that the first notice section issues notice of ending the work before the end time.

2. The robotic device according to claim 1, wherein
the controller further includes a first determination section configured to, based on the end time, determine time to issue the notice, and
the time to issue the notice is time before the end time.

3. The robotic device according to claim 2, further comprising
a first imaging section configured to capture an image to generate captured image data representing a result of capture, wherein
the controller further includes a determining section configured to, based on administrator information representing an administrator of the robotic device, determine whether or not an image of the administrator is contained in the captured image data.

4. The robotic device according to claim 3, further comprising
a communication section configured to communicate with an external device placed in a room that differs from a room where the robotic device is placed, wherein
the communication section communicates with the external device to receive captured image data generated by the external device,
the determining section
determines whether or not the image of the administrator is contained in the captured image data generated by the first imaging section based on the administrator information, and
determines whether or not the image of the administrator is contained in the captured image data generated by the external device based on the administrator information, and
the controller further includes a second determination section configured to determine which of the first notice section and the external device is to issue the notice based on results determined by the determining section.

5. The robotic device according to claim 4, wherein
the controller further includes a second calculation section configured to calculate a distance between the administrator and the robotic device based on the results determined by the determining section, and
based on the end time and the distance, the first determination section determines the time to issue the notice.

6. The robotic device according to claim 1, wherein
the first notice section issues the notice by audio.

7. The robotic device according to claim 1, wherein
the first notice section displays an image issuing the notice.

8. A robotic device controlling system comprising
a robotic device configured to perform work defined by a series of unit jobs, and
an external device configured to communicate with the robotic device through a network, wherein
the robotic device includes:
a first calculation section configured to calculate end time of the work;
a first determination section configured to determine time to issue notice of ending the work;
a first notice section configured to issue the notice;
a first imaging section configured to capture an image to generate captured image data representing a result of capture;
a determining section configured to determine whether or not an image of an administrator of the robotic device is contained in the captured image data;
a second determination section configured to determine a notice source of the notice; and
a first communication section configured to communicate with the external device,
the external device is placed in a room different from a room where the robotic device is placed, the external device including
a second imaging section configured to capture an image to generate captured image data representing a result of capture,
a second notice section configured to issue the notice; and
a second communication section configured to communicate with the robotic device,
the first calculation section calculates the end time based on time required for the work,
based on the end time, the first determination section determines the time to issue the notice,
the time to issue the notice is time before the end time,
the first communication section communicates with the second communication section to receive the captured image data generated by the second imaging section,
the determining section
determines whether or not the image of the administrator is contained in the captured image data generated by the first imaging section based on administrator information representing the administrator, and
determines whether or not the image of the administrator is contained in the captured image data generated by the second imaging section based on the administrator information,
the second determination section determines which of the first notice section and the second notice section is to issue the notice based on results determined by the determining section.

9. A robotic device controlling method of a robotic device that performs work defined by a series of unit jobs, the robotic device controlling method comprising
calculating end time of the work based on time required for the work, and
issuing notice of ending the work before the end time.
